(19) United States
(12) Patent Application Publication
(10) Pub. No.: US 2020/0063445 A1
(43) Pub. Date: Feb. 27, 2020

(54) DO IT YOURSELF DECK MEMBRANE

(71) Applicant: Benecke-Kaliko AG, Hannover (DE)

(72) Inventors: Kyle Lancaster, Winchester, VA (US); Grant Barlow, Wellsville, OH (US); John Morley, Haymarket, VA (US); Levi Rogers, Romney, WV (US)

(73) Assignee: Benecke-Kaliko AG, Hannover (DE)

(21) Appl. No.: 16/106,522

(22) Filed: Aug. 21, 2018

(51) Int. Cl. E04F 15/02; E04F 15/10; D06N 7/00

(52) U.S. Cl. CPC E04F 15/02183; B32B 27/304; D06N 7/0071; E04F 15/102

(57) ABSTRACT

A method of protecting an outdoor surface includes providing an outdoor surface and providing a single flexible vinyl membrane having a polyvinyl chloride upper layer with a thickness of from 0.02 inches to 0.06 inches and a polyethylene terephthalate nonwoven fabric lower layer having a weight of from 2 ounces/yard² to 6 ounces/yard². The single flexible vinyl membrane is installed by covering the outdoor surface with the single flexible vinyl membrane and affixing the single flexible vinyl membrane to the outdoor surface, and the single flexible vinyl membrane is installable onto the outdoor surface by a single individual. In some cases, the single flexible vinyl membrane is not installed by hot air welding. The single flexible vinyl membrane may further be trimmed to a shape similar to, or like the shape of the outdoor surface.

### FIELD

The field to which the disclosure generally relates to is flexible vinyl membranes which can be affixed to outdoor surfaces.

### BACKGROUND

This section provides background information to facilitate a better understanding of the various aspects of the disclosure. It should be understood that the statements in this section of this document are to be read in this light, and not as admissions of prior art.

Outdoor surfaces made from plastic, wood, concrete or composite materials require continuous maintenance to protect against deterioration and/or discoloration which is caused by the elements. For example, composite, concrete and plastic decks can require finishing (water sealing, stain, varnish, lacquer, wax, etc.) to be applied once or twice a year to prevent fading. Similarly, wood decks with finishing require regular applications to retain their vibrant color. Decks without finishing still demand frequent maintenance because they are more susceptible to rotting and warping than finished decks. Accordingly, most of today's decks can quickly become time consuming and expensive investments.

It is known to apply vinyl membranes to outdoor surfaces using very specialized techniques which require specific equipment, such as hot air welding. However, such installations are time consuming, expensive and require trained installers to apply the vinyl membranes to outdoor surfaces.

There is a demand for vinyl membranes which are very simple to install, require no specialized equipment nor training, and which provide easy maintenance outdoor plastic, concrete, wood, or composite structures, such need met, at least in part, with embodiments according to the following disclosure.

### SUMMARY

This section provides a general summary of the disclosure, and is not a necessarily a comprehensive disclosure of its full scope or all of its features.

In a first aspect of the disclosure, a method of protecting an outdoor surface includes providing an outdoor surface and providing a single flexible vinyl membrane having a polyvinyl chloride upper layer with a thickness of from 0.02 inches to 0.06 inches and a polyethylene terephthalate nonwoven fabric lower layer having a weight of from 2 ounces/yard² to 6 ounces/yard². The single flexible vinyl membrane is installed by covering the outdoor surface with the single flexible vinyl membrane and affixing the single flexible vinyl membrane to the outdoor surface, and the single flexible vinyl membrane is installable onto the outdoor surface by a single individual. In some cases, the single flexible vinyl membrane is not installed by hot air welding. The single flexible vinyl membrane may further be trimmed to a shape similar to, or like the shape of the outdoor surface. Perimeter edging may also be installed around one or more outside edges of the single flexible vinyl membrane.

The single flexible vinyl membrane may be affixed to the outdoor surface by applying pressure to activate a pressure sensitive adhesive. In some cases, the pressure sensitive adhesive is located on a lowest surface of the single flexible vinyl membrane. In some other cases, the pressure sensitive adhesive is applied onto the outdoor surface prior to applying pressure. In some other instances, the single flexible vinyl membrane is affixed to the outdoor surface using a plurality of mechanical connectors.

In some aspects the single flexible vinyl membrane includes the polyethylene terephthalate nonwoven fabric lower layer in a weight of from about 2.5 ounces/yard² to about 3.5 ounces/yard², or even in a weight of about 3 ounces/yard². In some cases, the single flexible vinyl membrane includes the polyvinyl chloride upper layer in a thickness of from about 0.035 inches to about 0.045 inches, or even about 0.04 inches.

In another aspect of the disclosure, a single flexible vinyl membrane includes a polyvinyl chloride upper layer having a thickness of from about 0.035 inches to about 0.045 inches and a polyethylene terephthalate nonwoven fabric lower layer having a weight of from about 2.5 ounces/yard² to about 3.5 ounces/yard². The single flexible vinyl membrane may further include a pressure sensitive adhesive on a lowest surface of the single flexible vinyl membrane.

In yet other aspects of the disclosure, single flexible vinyl membrane consist of simply a polyvinyl chloride upper layer having a thickness of from about 0.035 inches to about 0.045 inches and a polyethylene terephthalate nonwoven fabric lower layer having a weight of from about 2.5 ounces/yard² to about 3.5 ounces/yard². In some cases, the polyethylene terephthalate nonwoven fabric lower layer has a weight of about 3 ounces/yard², and the polyvinyl chloride upper layer may have a thickness of inches of about 0.04 inches.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIGS. 1 and 2 show a single flexible vinyl membrane, in a perspective view according to the disclosure;

FIG. 3 illustrates outdoor surface to be protected, in a perspective view, according to the disclosure;

FIG. 4 depicts an intermediate stage of installation of a single flexible vinyl membrane to protect an outdoor surface, in a perspective view, according to the disclosure; and,

FIG. 5 shows the installed single flexible vinyl membrane onto outdoor surface, in a perspective view, according to the disclosure.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Embodiments according to the disclosure utilize a single flexible vinyl membrane having an aesthetically pleasing external appearance. The single flexible vinyl membrane includes a polyvinyl chloride upper layer having a thickness of from about 0.02 inches to about 0.06 inches, and a polyethylene terephthalate nonwoven fabric lower layer having a weight of from about 2 ounces/yard² to about 6 ounces/yard². In some aspects, the single flexible vinyl membrane includes the polyethylene terephthalate nonwoven fabric lower layer in a weight of from about 2.5 ounces/yard² to about 3.5 ounces/yard², or even about 3 ounces/yard². In some aspects the single flexible vinyl membrane includes the polyvinyl chloride upper layer in a thickness of from about 0.035 inches to about 0.045 inches, or even a thickness of inches about 0.04 inches.

The single flexible vinyl membrane generally is a homogeneous piece of high performance PVC membrane double-ply embossed & printed vinyl sheet laminated to non-woven scrim. The single flexible vinyl membrane used in accordance with the disclosure has the following physical properties:

TABLE 1

| Property Description | Property Value | Test Standard |
|---|---|---|
| Elongation: | >250% | ASTM D751-B |
| Breaking Strength: | >245N | ASTM D751-B |
| Tear Strength: | >45N | ASTM D1004 |
| Low Temperature: | −40° C. | ASTM D2136 |
| Seam Strength: | ≥75% of Breaking | ASTM D751-B |
| | Strength | |
| Accelerated Weathering: | No Cracking or | ASTM G154 |
| | Crazing | |
| Heat Resistance: | ≥90% Retention of | ASTM D751-B |
| | Elongation & Tensile | |
| | (56 days @ 80° C.) | |
| Linear Dimensional Change: | 0.1% max. | ASTM D1204 |
| Water Immersion Wt Change: | +/−3% max. | ASTM D570 |
| Static Puncture Resistance: | Pass @ 15 kg Load | ASTM D5602 |
| Dynamic Puncture Resistance: | Pass @ 10 J Energy | ASTM D5635 |

The PVC compound used for the single flexible vinyl membrane is vinyl chloride resin, and vinyl chloride resin refers to a homopolymer or a copolymer including vinyl chloride of 50% or higher. Vinyl chloride resin is characterized in that it has low crystallinity and it is difficult to adhere at the time of processing. However, vinyl chloride resin is a soft product and used in sheets or films for packaging and agriculture. In manufacture, the PVC compound is laminated, or otherwise laid on top of the polyethylene terephthalate nonwoven fabric lower layer to make the flexible vinyl membrane.

Generally, the polyethylene terephthalate nonwoven fabrics refer to an assembly of textile fibers held together by interlocking in a random web or mat, by fusing of the fibers, or by bonding with an adhesive. These may also be composed of randomly arranged, continuous filament fibers bonded at filament cross-over points. These fabrics are lightweight and have good tensile and tear strengths. In some cases, the polyethylene terephthalate nonwoven fabrics are composed of fibers entangled in a predetermined repeating pattern to form a strong, non-bonded structure.

The single flexible vinyl membranes utilized according to the disclosure provide the advantage that a single individual can install a single flexible vinyl membrane onto an outdoor surface without the need of specialized tools (such as a hot air welder) or training. In some aspects, the single flexible vinyl membrane is adhered to the outdoor surface using a conventional and suitable which adhesive applied directly onto the outdoor surface to be protected. In some other cases, the single flexible vinyl membrane is adhered to the outdoor surface using a pressure sensitive adhesive which is applied onto the outer lower surface of the nonwoven fabric during manufacture of the single flexible vinyl membrane.

The single flexible vinyl membranes may, in some cases, be of a foamed structure utilizing foaming agents know to those of skill in the art in the manufacture of such membranes. In some other aspects, the single flexible vinyl membranes are not foamed structures, having no substantial air/gas pockets entrained therein, and are thus continuously solid structures devoid of gas pockets formed from foaming agents.

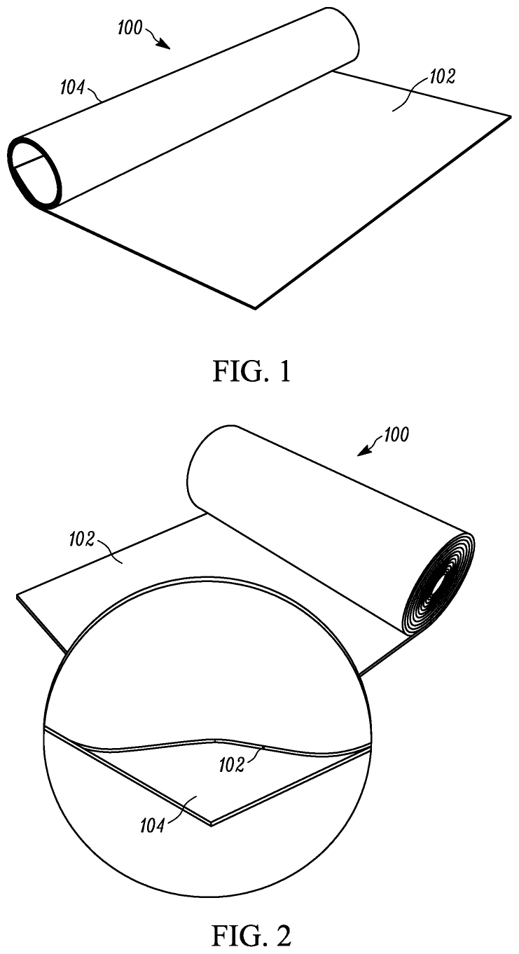

Now with reference to FIG. 1, single flexible vinyl membrane 100 is shown in a perspective view, as a partial roll. Single flexible vinyl membrane 100 includes a polyvinyl chloride upper layer 102 and a polyethylene terephthalate nonwoven fabric lower layer 104. FIG. 2 illustrates the configuration of the polyvinyl chloride upper layer 102 and polyethylene terephthalate nonwoven fabric lower layer 104 in further detail.

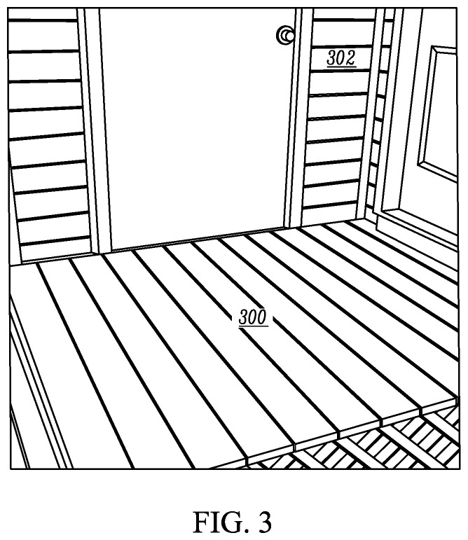

With reference to FIG. 3, an outdoor surface 300, which is shown as a wood deck extending outward from a house 302, is one non-limiting example of an outdoor surface to be protected. Other type's outdoor surfaces include, but are not limited to, porches, pool surrounds, concrete, patios, garage floors, roofs, dog runs, trailer beds, boat decks, and the like.

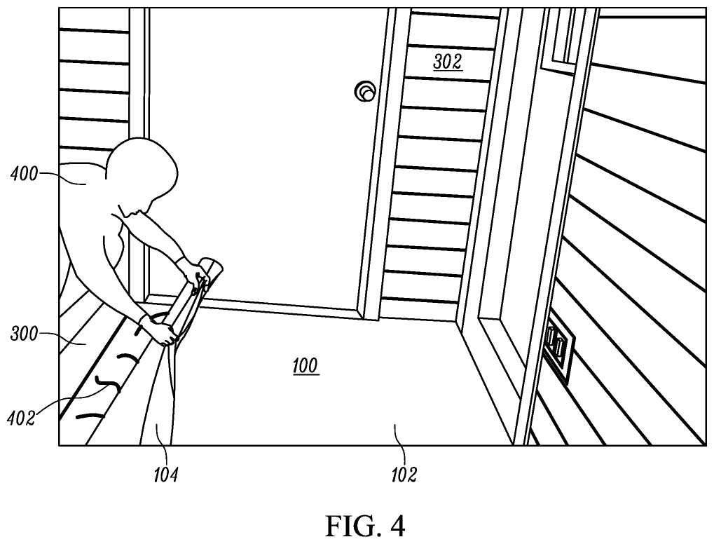

Now referencing FIG. 4, which depicts an intermediate stage of installation of a single flexible vinyl membrane to protect an outdoor surface. An outdoor surface 300 is provided for protection as well as a single flexible vinyl membrane 100, having polyvinyl chloride upper layer 102 and polyethylene terephthalate nonwoven fabric lower layer 104. Single flexible vinyl membrane 100 is installed by a single individual 400. In the example shown, single individual 400 applies a liquid adhesive 402 upon outdoor surface 300, before covering the outdoor surface with the single flexible vinyl membrane 100. Liquid adhesive 402 ultimately affixes the single flexible vinyl membrane 100 to the outdoor surface 300. While liquid adhesive 402 is shown for affixing membrane 100 to surface 300, membrane 100 may be installed on surface 300 using double sided exterior tape, staples, contact adhesive, screws, and the like.

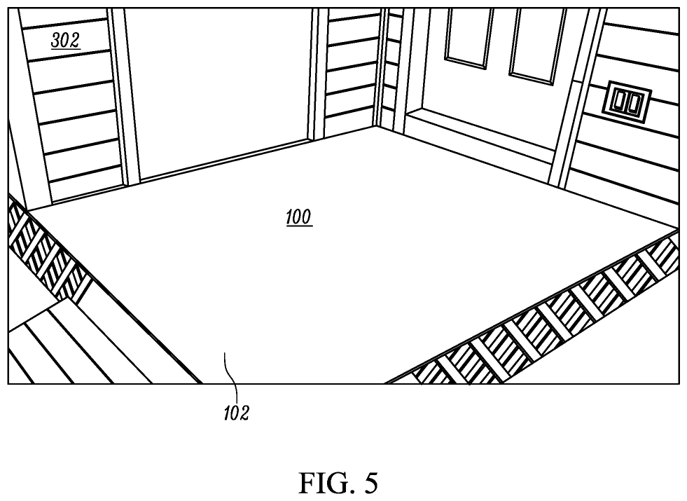

FIG. 5 shows the installed single flexible vinyl membrane 100 onto outdoor surface 300, having polyvinyl chloride upper layer 102 in the upward orientation.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

### LISTING OF REFERENCE NUMERAL (PART OF THE SPECIFICATION)

100 Single flexible vinyl membrane
102 Polyvinyl chloride upper layer
104 Polyethylene terephthalate nonwoven fabric lower layer
300 Outdoor surface
302 Home
400 Individual
402 Adhesive

What is claimed is:

1. A method of protecting an outdoor surface, the method comprising:
providing an outdoor surface;
providing a single flexible vinyl membrane comprising a polyvinyl chloride upper layer having a thickness of from 0.02 inches to 0.06 inches and a polyethylene terephthalate nonwoven fabric lower layer having a weight of from 2 ounces/yard² to 6 ounces/yard²;
installing the single flexible vinyl membrane by covering the outdoor surface with the single flexible vinyl membrane and affixing the single flexible vinyl membrane to the outdoor surface;
wherein the single flexible vinyl membrane is installable onto the outdoor surface by a single individual.

2. The method according to claim 1 provided the single flexible vinyl membrane is not installed by hot air welding.

3. The method according to claim 1 further comprising trimming the single flexible vinyl membrane to a shape similar to a shape of the outdoor surface.

4. The method according to claim 1 further comprising installing perimeter edging around one or more outside edges of the single flexible vinyl membrane.

5. The method according to claim 1, wherein the single flexible vinyl membrane is affixed to the outdoor surface by applying pressure to activate a pressure sensitive adhesive.

6. The method according to claim 5, wherein the pressure sensitive adhesive is comprised on a lowest surface of the single flexible vinyl membrane.

7. The method according to claim 5, wherein the pressure sensitive adhesive is applied onto the outdoor surface prior to the applying pressure.

8. The method according to claim 1, wherein the single flexible vinyl membrane is affixed to the outdoor surface using a plurality of mechanical connectors.

9. The method according to claim 1, wherein the single flexible vinyl membrane comprises the polyethylene terephthalate nonwoven fabric lower layer in a weight of from 2.5 ounces/yard² to 3.5 ounces/yard².

10. The method according to claim 9, wherein the single flexible vinyl membrane comprises the polyethylene terephthalate nonwoven fabric lower layer in a weight of 3 ounces/yard².

11. The method according to claim 1, wherein the single flexible vinyl membrane comprises the polyvinyl chloride upper layer in a thickness of from 0.035 inches to 0.045 inches.

12. The method according to claim 1, wherein the single flexible vinyl membrane comprises the polyvinyl chloride upper layer in a thickness of inches of 0.04 inches.

13. The method according to claim 1, wherein the single flexible vinyl membrane is a solid structure devoid of gas pockets formed from foaming agents.

14. A single flexible vinyl membrane comprising a polyvinyl chloride upper layer having a thickness of from 0.035 inches to 0.045 inches and a polyethylene terephthalate nonwoven fabric lower layer having a weight of from 2.5 ounces/yard² to 3.5 ounces/yard².

15. The single flexible vinyl membrane according to claim 14 further comprising a pressure sensitive adhesive on a lowest surface of the single flexible vinyl membrane.

16. The single flexible vinyl membrane according to claim 14 comprising the polyethylene terephthalate nonwoven fabric lower layer in a weight of 3 ounces/yard².

17. The single flexible vinyl membrane according to claim 14 comprising the polyvinyl chloride upper layer in a thickness of inches of 0.04 inches.

18. A single flexible vinyl membrane consisting of a polyvinyl chloride upper layer having a thickness of from 0.035 inches to 0.045 inches and a polyethylene terephthalate nonwoven fabric lower layer having a weight of from 2.5 ounces/yard² to 3.5 ounces/yard².

19. The single flexible vinyl membrane according to claim 18 comprising the polyethylene terephthalate nonwoven fabric lower layer in a weight of 3 ounces/yard².

20. The single flexible vinyl membrane according to claim 18 comprising the polyvinyl chloride upper layer in a thickness of inches of 0.04 inches.
